(19) United States
(12) Patent Application Publication
(10) Pub. No.: US 2019/0319682 A1
(43) Pub. Date: Oct. 17, 2019

(54) FEEDBACK OF SPARSE CORRELATION MATRIX FOR MULTIPLE-INPUT AND MULTIPLE-OUTPUT (MIMO) WIRELESS NETWORKS

(71) Applicant: NOKIA SOLUTIONS AND NETWORKS OY, Espoo (FI)

(72) Inventors: Yi Zhang, Beijing (CN); Yuantao Zhang, Beijing (CN); Deshan Miao, Beijing (CN)

(21) Appl. No.: 16/065,087

(22) PCT Filed: Dec. 23, 2015
(86) PCT No.: PCT/CN2015/098375

§ 371 Date: Jun. 21, 2018

(51) Int. Cl. H04B 7/0417; H04L 5/00; H04B 7/06

(52) U.S. Cl. CPC H04B 7/0417; H04L 5/0048; H04B 7/0632; H04B 7/0617; H04B 7/0626

(57) ABSTRACT

A technique is provided for receiving, by a user device from a base station, a first reference signal via a plurality of base station transmit beams; selecting, based on the first reference signal received via the plurality of transmit beams, beam indices for a subset of correlation coefficients to be reported to the measurement base station; receiving, by the user device from the base station, a second reference signal via a plurality of the transmit beams; determining, based on the selected beam indices, the subset of correlation coefficients of a correlation matrix based on the second reference signal received via each of the plurality of transmit beams; and reporting, by the user device to the base station, the subset of correlation coefficients.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed. Other example spectrums may also be used, such as cmWave radio spectrum (3-30 GHz).

### SUMMARY

According to an example implementation, a method may include receiving, by a user device from a base station, a number of correlation coefficients of a correlation matrix to be reported to the base station, wherein the number of correlation coefficients is a subset of all correlation coefficients of the correlation matrix; determining, based on the number, a subset of non-zero correlation coefficients that represent a correlation of base station transmit beams; and reporting, by the user device to the base station, the subset of non-zero correlation coefficients.

According to an example implementation, an apparatus includes at least one processor and at least one memory including computer instructions, when executed by the at least one processor, cause the apparatus to: receive, by a user device from a base station, a number of correlation coefficients of a correlation matrix to be reported to the base station, wherein the number of correlation coefficients is a subset of all correlation coefficients of the correlation matrix; determine, based on the number, a subset of non-zero correlation coefficients that represent a correlation of base station transmit beams; and report, by the user device to the base station, the subset of non-zero correlation coefficients.

According to an example implementation, an apparatus includes means for receiving, by a user device from a base station, a number of correlation coefficients of a correlation matrix to be reported to the base station, wherein the number of correlation coefficients is a subset of all correlation coefficients of the correlation matrix; means for determining, based on the number, a subset of non-zero correlation coefficients that represent a correlation of base station transmit beams; and means for reporting, by the user device to the base station, the subset of non-zero correlation coefficients.

According to an example implementation, a computer program product includes a computer-readable storage medium and storing executable code that, when executed by at least one data processing apparatus, is configured to cause the at least one data processing apparatus to perform a method including: receiving, by a user device from a base station, a number of correlation coefficients of a correlation matrix to be reported to the base station, wherein the number of correlation coefficients is a subset of all correlation coefficients of the correlation matrix; determining, based on the number, a subset of non-zero correlation coefficients that represent a correlation of base station transmit beams; and reporting, by the user device to the base station, the subset of non-zero correlation coefficients.

According to an example implementation, a method may include receiving, by a user device from a base station, a first reference signal via a plurality of base station transmit beams; selecting, based on the first reference signal received via the plurality of transmit beams, beam indices for a subset of correlation coefficients to be reported to the base station; receiving, by the user device from the base station, a second reference signal via a plurality of the transmit beams; determining, based on the selected beam indices, the subset of correlation coefficients of a correlation matrix based on the second reference signal received via each of the plurality of transmit beams; and reporting, by the user device to the base station, the subset of correlation coefficients.

According to an example implementation, an apparatus includes at least one processor and at least one memory including computer instructions, when executed by the at least one processor, cause the apparatus to: receive, by a user device from a base station, a first reference signal via a plurality of base station transmit beams; select, based on the first reference signal received via the plurality of transmit beams, beam indices for a subset of correlation coefficients to be reported to the base station; receive, by the user device from the base station, a second reference signal via a plurality of the transmit beams; determine, based on the selected beam indices, the subset of correlation coefficients of a correlation matrix based on the second reference signal received via each of the plurality of transmit beams; and report, by the user device to the base station, the subset of correlation coefficients.

According to an example implementation, an apparatus includes means for receiving, by a user device from a base station, a first reference signal via a plurality of base station transmit beams; means for selecting, based on the first reference signal received via the plurality of transmit beams, beam indices for a subset of correlation coefficients to be reported to the base station; means for receiving, by the user device from the base station, a second reference signal via a plurality of the transmit beams; means for determining, based on the selected beam indices, the subset of correlation coefficients of a correlation matrix based on the second reference signal received via each of the plurality of transmit beams; and means for reporting, by the user device to the base station, the subset of correlation coefficients.

According to an example implementation, a computer program product includes a computer-readable storage medium and storing executable code that, when executed by at least one data processing apparatus, is configured to cause the at least one data processing apparatus to perform a method including: receiving, by a user device from a base station, a first reference signal via a plurality of base station transmit beams; selecting, based on the first reference signal received via the plurality of transmit beams, beam indices for a subset of correlation coefficients to be reported to the base station; receiving, by the user device from the base station, a second reference signal via a plurality of the transmit beams; determining, based on the selected beam indices, the subset of correlation coefficients of a correlation matrix based on the second reference signal received via each of the plurality of transmit beams; and reporting, by the user device to the base station, the subset of correlation coefficients.

According to an example implementation, a method may include sending, by a base station to a user device, a first reference signal via a plurality of base station transmit beams; receiving, by the base station as measured by the user device based on the first reference signal, a measured power and a beam index associated with the first reference signal for each of a plurality of the transmit beams; sending, by the base station to a user device, a number of correlation coefficients of a correlation matrix to be reported to the base station; sending, by the base station, a second reference signal via a plurality of the base station transmit beams; and receiving, by the base station from the user device, a subset of non-zero correlation coefficients of a correlation matrix based on the second reference signal.

According to an example implementation, an apparatus includes at least one processor and at least one memory including computer instructions, when executed by the at least one processor, cause the apparatus to: send, by a base station to a user device, a first reference signal via a plurality of base station transmit beams; receive, by the base station as measured by the user device based on the first reference signal, a measured power and a beam index associated with the first reference signal for each of a plurality of the transmit beams; send, by the base station to a user device, a number of correlation coefficients of a correlation matrix to be reported to the base station; sending, by the base station, a second reference signal via a plurality of the base station transmit beams; and receive, by the base station from the user device, a subset of non-zero correlation coefficients of a correlation matrix based on the second reference signal.

According to an example implementation, an apparatus includes means for sending, by a base station to a user device, a first reference signal via a plurality of base station transmit beams; means for receiving, by the base station as measured by the user device based on the first reference signal, a measured power and a beam index associated with the first reference signal for each of a plurality of the transmit beams; means for sending, by the base station to a user device, a number of correlation coefficients of a correlation matrix to be reported to the base station; means for sending, by the base station, a second reference signal via a plurality of the base station transmit beams; and means for receiving, by the base station from the user device, a subset of non-zero correlation coefficients of a correlation matrix based on the second reference signal.

According to an example implementation, a computer program product includes a computer-readable storage medium and storing executable code that, when executed by at least one data processing apparatus, is configured to cause the at least one data processing apparatus to perform a method including: sending, by a base station to a user device, a first reference signal via a plurality of base station transmit beams; receiving, by the base station as measured by the user device based on the first reference signal, a measured power and a beam index associated with the first reference signal for each of a plurality of the transmit beams; sending, by the base station to a user device, a number of correlation coefficients of a correlation matrix to be reported to the base station; sending, by the base station, a second reference signal via a plurality of the base station transmit beams; and receiving, by the base station from the user device, a subset of non-zero correlation coefficients of a correlation matrix based on the second reference signal.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram of a wireless transceiver according to an example implementation.

FIG. 3 is a diagram illustrating an antenna array according to an example implementation.

FIG. 4 is a diagram illustrating a sub-array according to an example implementation.

FIG. 5 is a diagram illustrating operation of a wireless network that includes a transmission of a sparse correlation matrix for a grid of beams (GoBs) or M-MIMO system according to an example implementation.

FIG. 6 is a flow chart illustrating operation of a user device according to an example implementation.

FIG. 7 is a flow chart illustrating operation of a user device according to an example implementation.

FIG. 8 is a flow chart illustrating operation of a base station according to an example implementation.

FIG. 9 is a block diagram of a wireless station (e.g., base station/access point or mobile station/user device) according to an example implementation.

### DETAILED DESCRIPTION

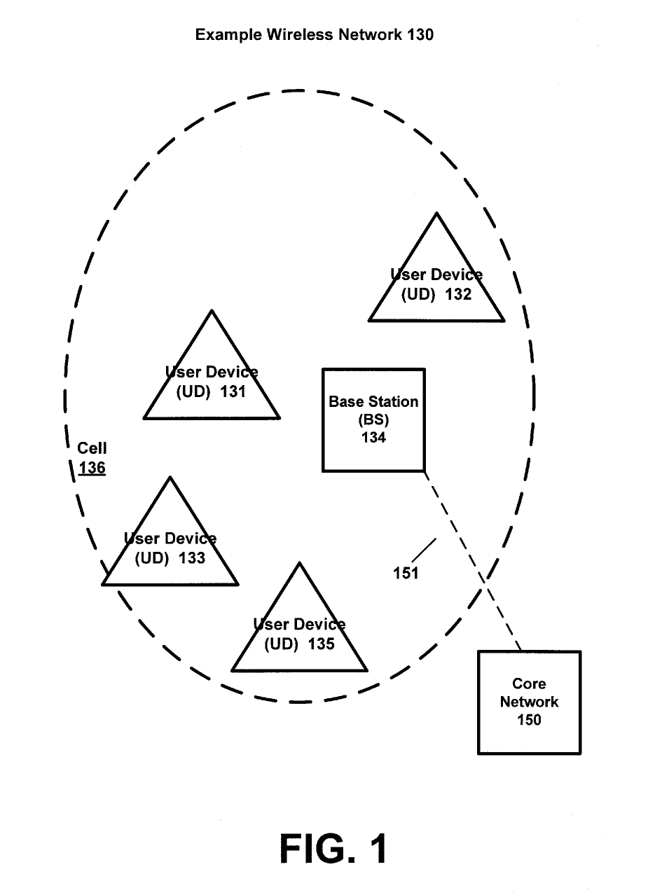

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS), which may also be referred to as an access point (AP), an enhanced Node B (eNB) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, or any other wireless network. LTE, 5G, cmWave and mmWave band networks are provided only as illustrative examples, and the various example implementations may be applied to any wireless technology/wireless network.

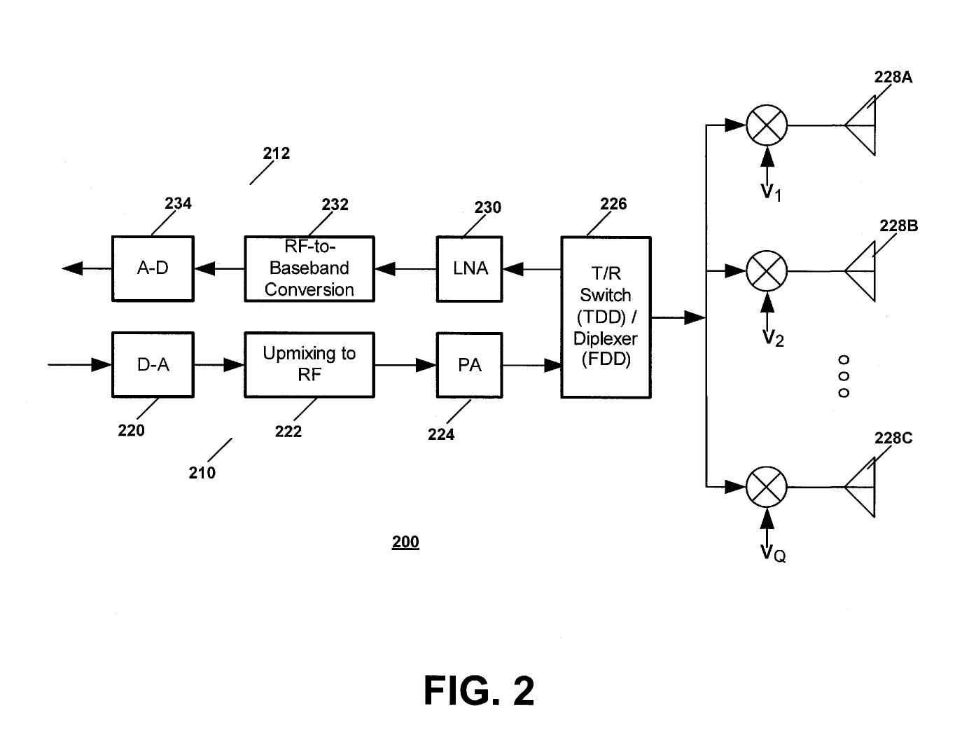

FIG. 2 is a diagram of a wireless transceiver according to an example implementation. Wireless transceiver 200 may be used, for example, at a base station (BS), e.g., Access Point (AP) or eNB, or other wireless device. Wireless transceiver 200 may include a transmit path 210 and a receive path 212.

In transmit path 210, a digital-to-analog converter (D-A) 220 may receive a digital signal from one or more applications and convert the digital signal to an analog signal. Upmixing block 222 may up-convert the analog signal to an RF (e.g., radio frequency) signal. Power amplifier (PA) 224 then amplifies the up-converted signal. According to an example implementation, the power amplifier may be integrated to or with an antenna element. The amplified signal is then passed through a transmit/receive (T/R) switch (or Diplexer 226 for frequency division duplexing, to change frequencies for transmitting). The signal output from T/R switch 226 is then output to one or more antennas in an array of antennas 228, such as to antenna 228A, 228B and/or 228C. Prior to being transmitted by one or more of the antennas in the array of antennas 228, a set of beam weights V₁, V₂, . . . or V_{Q} is mixed with the signal to apply a gain and phase to the signal for transmission. For example, a gain and phase, V₁, V₂, . . . or V_{Q}, may be applied to the signal output from the T/R switch 226 to scale the signal transmitted by each antenna (e.g., the signal is multiplied by V₁ before being transmitted by antenna 1 228A, the signal is multiplied by V₂ before being transmitted by antenna 2 228B, and so on), where the phase may be used to steer or point a beam transmitted by the overall antenna array, e.g., for directional beam steering. Thus, the beam weights V₁, V₂, . . . or V_{Q} (e.g., each beam weight including a gain and/or phase) may be a set of transmit beamforming beam weights when applied at or during transmission of a signal to transmit the signal on a specific beam, and may be a set of receive beamforming beam weights when applied to receive a signal on a specific beam.

In receive path 212 of wireless transceiver 200, a signal is received via an array of antennas 228, and is input to T/R switch 226, and then to low noise amplifier (LNA) 230 to amplify the received signal. According to an example implementation, the LNA may be co-located with an antenna element. The amplified signal output by LNA 230 is then input to a RF-to-baseband conversion block 232 where the amplified RF signal is down-converted to baseband. An analog-to-digital (A-D) converter 234 then converts the analog baseband signal output by conversion block 232 to a digital signal for processing by one or more upper layers/application layers.

Various example implementations may relate, for example, to 5G radio access systems (or other systems) with support for Massive MIMO (multiple input, multiple output) and optimized for operating in high carrier frequencies such as cmWave frequencies (e.g. from 3 GHz onwards) or mmWave frequencies, as examples, according to an illustrative example implementation. Those illustrative systems are typically characterized by the need for high antenna gain to compensate for increased pathloss and by the need for high capacity and high spectral efficiency to respond to ever increasing wireless traffic. According to an example implementation, the increased attenuation at higher carrier frequencies may, for example, be compensated by introducing massive (multi-element) antenna arrays and correspondingly antenna gain via beamforming at the access point (AP)/base station (BS) and/or user device. The spectral efficiency may typically improve with the number spatial streams the system can support and thus with the number of antenna ports at the AP/BS. According to an example implementation, spatial multiplexing may include a transmission technique in MIMO wireless communication to transmit independent and separately encoded data signals, so-called streams, from each of the multiple transmit antennas.

For example, for massive multiple input multiple output (M-MIMO) system, a large number of antenna elements may typically be used at a transmitter and/or receiver (e.g., at a base station/access point or other network node). M-MIMO may typically have more spatial links/layers and provides more spatial degrees of freedom. In an illustrative example, with well designed antenna weights, a MIMO or M-MIMO transmitter can generate relatively narrow beams with good spatial separation. Thus, such a transmitter can achieve greater beamforming gain, reduce the spatial interference range and obtain greater multiple user spatial multiplexing gain. A MIMO or M-MIMO system may typically have better performance in terms of data rate and link reliability compared with other systems.

In an example implementation, a Grid of beams (GoB) transmitter may be used in a M-MIMO system, where each beam is designed to have a fixed direction and is used to cover a certain spatial region. Each beam in a GoB system may be generated by a sub-array, for example. According to an example implementation, a virtual channel after one fixed GoB precoding may be referred to as a channel or a channel component. Multiple beams are simultaneously transmitted to guarantee the coverage of whole cell, with each beam being transmitted by an antenna port and beam. Thus, for example, each antenna port (and also one sub-array) of an antenna may generate one beam. Thus, in an example implementation, each beam may be generated by an antenna sub-array. In MIMO, a number of channels may be established, including, for example, a channel may between each transmit antenna port/beam at a BS and each receive antenna port/beam at a user device/UE. Since each beam has finer width and direction, typically only some (e.g., subset) of the beams may be used to communicate with a specific UE/user device. Thus, the power of channel components/channel coefficients corresponding to a most/many beams may be almost zero (or near zero). A channel coefficient may identify a gain and phase for a channel between a transmit antenna port/beam and a receive antenna port/beam. Thus, the channel matrix composed by all the channel components (or channel coefficients) has a sparse property, e.g., where sparse may refer to a matrix of coefficients where a significant number (e.g., most) of such coefficients are zero or near zero, and/or a few or relatively small number of coefficients in the matrix of coefficients are significantly greater than zero, for example. Thus, sparse may refer to a situation where a matrix of coefficients may be sparsely populated (e.g., less than half, and in some cases significantly less than half the coefficients) with coefficients/components that are non-zero or significantly greater than zero. Explicit feedback for channel components/coefficients can be used for a BS to obtain accurate channel state information (CSI).

According to an example implementation, a correlation of a transmit beams may be performed to obtain a matrix (R) of correlation coefficients. Each correlation coefficient r_{i,j} may represent a correlation between the iₜₕ transmit beam and the jₜₕ transmit beam of the BS/AP. The correlation matrix R may include a plurality of diagonal correlation (auto-correlation) coefficients that represent a correlation of a transmit beam with itself (e.g., with auto-correlation coefficients, r_{i,j}, with i=j). The correlation matrix R may also include non-diagonal correlation (cross-correlation) coefficients that represent a cross-correlation of two different transmit beams of a BS/AP (e.g., with cross correlation coefficients r_{i,j}, with i not equal to j). A feedback of one or more correlation coefficients may also provide explicit feedback.

According to an example implementation, a reference signal may be transmitted by a BS via each of a plurality of beams to one or more user devices/UEs. A UE may measure a power of the received reference signal via one of the antenna ports (e.g., port 0) to obtain channel information. However, with MIMO and the use of beamforming, including the transmission of signals via a plurality of beams, and/or receiving of a signal via a plurality of receive beams/receive antenna ports, measuring received power (reference signal received power/RSRP) on just one antenna port/beam may not necessarily provide accurate channel information. For example, when a GoB scheme is used for m-MIMO system, the power difference between different antenna ports will become significant. Thus, merely measuring RSRP from only one antenna port (or for only one transmit beam), will not typically provide a clear picture of large scale power level for all the antenna ports of one UE. A UE may report or provide explicit feedback, e.g., a quantized representation of the channel state information/CSI (such as channel coefficients or correlation coefficients) without making assumptions about the nature of the BS precoder. In addition, or in the alternative, a UE may provide or report to the BS implicit feedback, e.g., which may provide an implicit representation of a channel, such as providing an indication of a data rate that could be achieved if the BS used a specific precoder. Thus, one example form of implicit feedback may include providing a channel quality indicator (CQI) and/or a rank indicator (RI).

According to an example implementation, sending explicit feedback for channel state information/CSI, e.g., in the form of channel coefficients or correlation coefficients, may be referred to as explicit feedback, and may, at least in some cases, create significant overhead. However, according to an example implementation, the feedback overhead for explicit feedback can be reduced by exploiting a sparse property of a channel matrix or by exploiting a sparse property of a correlation matrix (e.g., by reporting/feeding back to the BS only a subset of identified non-zero correlation coefficients). With accurate CSI, the BS can make efficient single user (SU) and multiple user (MU) MIMO transmission, e.g., by selecting MIMO weights based on the channel state information.

According to one or more illustrative example implementations, explicit feedback may provided for a GoB/M-MIMO system to achieve greater capacity gain compared with that achieved by using implicit feedback, while reducing or limiting the feedback overhead (e.g., as compared to explicit feedback that reports all channel state information for all channels) with the assistance of a sparse channel property with respect to M-MIMO or GoB system, e.g., where, for example, only a subset of the antenna ports/transmit beams may be relevant (e.g., having significant or non-zero RSRP) for a UE, e.g., due to the highly directional nature of each beam in a GoB or M-MIMO system, for example.

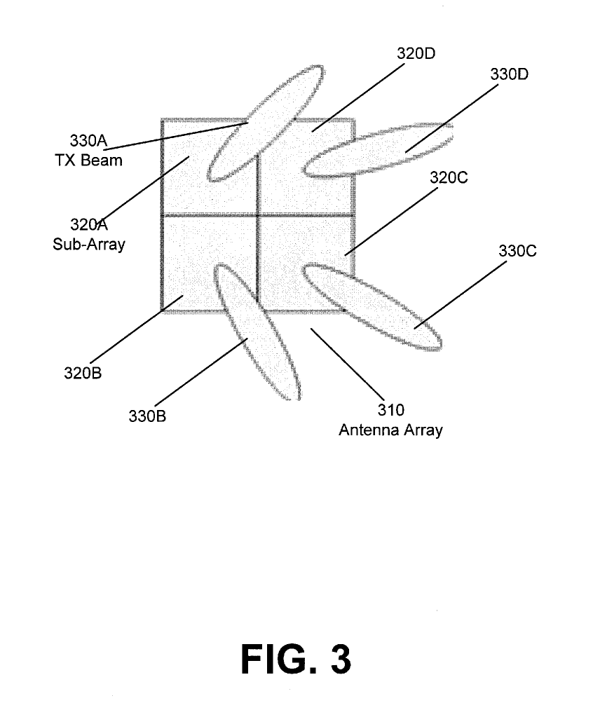

FIG. 3 is a diagram illustrating an antenna array according to an example implementation. The antenna array (or antenna) 310 illustrated in FIG. 3 may be used, for example, to generate a grid of beams (GoBs). For example, antenna array 310 may include a plurality of sub-arrays 320, where each sub-array 320 may generate an associated beam 330, with each beam provided in a different direction. For example, sub-array 320A may generate a beam 330A; sub-array 320B may generate a beam 330B; sub-array 320C may generate a beam 330C, sub-array 320D may generate a beam 330D, etc. Only some of the sub-arrays and beams are shown in the example antenna array 310. Antenna array 310 may include any number of sub-arrays or beams, for example.

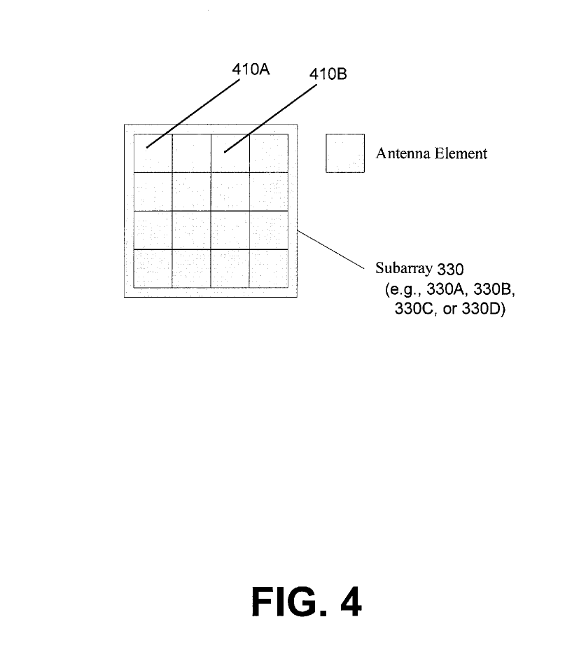

FIG. 4 is a diagram illustrating a sub-array according to an example implementation. Sub-array 330 may include a plurality of antenna elements, such as antenna elements 410A, 410B, etc. A different beam weight may be applied to each antenna element. A set of weights applied to the antenna elements of the sub-array may generate a beam in specific direction, for example.

According to an example implementation, a sparse spatial correlation matrix (R for short) is provided as explicit feedback for GoB M-MIMO system. It exploits the sparse property of the spatial correlation matrix to reduce the feedback overhead, where very small antenna gain for some antenna ports/transmit beams by highly directional antennas result in many zero spatial correlation values within a correlation matrix. Therefore, according to an example implementation, if the indices (e.g., indices i, j, that identify the correlation coefficient, where i and j are associated with or identify two antenna ports/transmit beams being correlated) of near-zero spatial correlation values are known by a BS, it is not necessary to provide any feedback on these zero/near-zero correlation coefficients. Then, according to an example implementation, only the larger (e.g., non-zero) spatial correlation values together with or without their indices are needed as feedback to the BS. According to an illustrative example, this feedback scheme may be referred to as a sparse R (sparse correlation matrix) based explicit feedback.

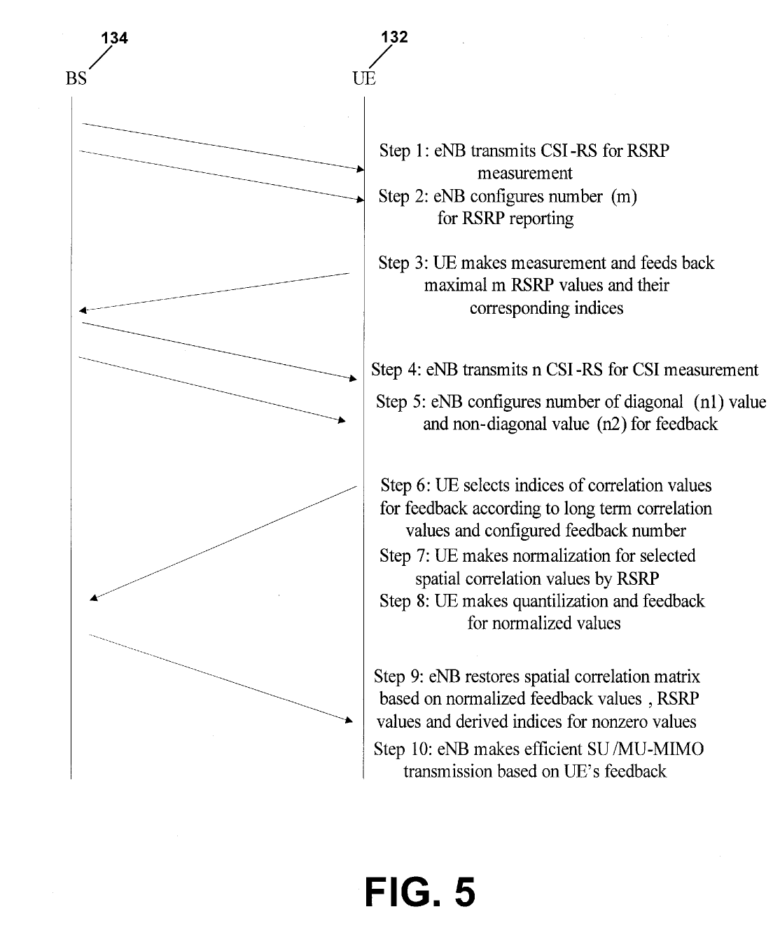

FIG. 5 is a diagram illustrating operation of a wireless network that includes a transmission of a sparse correlation matrix for a grid of beams (GoBs) or M-MIMO system according to an example implementation. At step 1, BS (eNB) 134 transmits a reference signal (CSI-RS) for UE RSRP (reference signal received power) measurement. The reference signal may be transmitted via a plurality of BS antenna ports/BS transmit beams. In an example implementation, the reference signal may be a CSI-RS with a (relatively) long period (long term reference signal). Also, at step 1, BS 134 may also configure or notify UE 132 of the resource location of the reference signal for each antenna port/transmit beam, for example, e.g., to allow the UE 132 to measure the RSRP of the reference signal for each of the antenna ports/transmit beams. In this manner, the beam index (associated with or identifying each beam) may be determined by the UE based on the resource used measure the power (e.g., RSRP) of the reference signal.

At step 2 of FIG. 5, BS 134 may configure the UE 132 or notify the UE 132 of the number of beams for RSRP reporting, for example m.

At step 3 of FIG. 5, the UE 132 receives the long-term reference signal transmitted via each of a plurality of transmit beams (transmitted at step 1). The UE 132 measures the power (e.g., RSRP) of the reference signal received via each transmit beam. UE 132 determines the beam index (e.g., i) for the m transmit beams having the greatest/highest RSRP. Also, at step 3, the UE 132 feeds back or reports the RSRP/power value and transmit beam indices of the m beams having the highest/greatest power/RSRP, based on UE's measurement (at step 3) of power/RSRP of the long-term reference signal received via the plurality of transmit beams. Thus, the UE 132 reports to BS 134 the power and indices of the m highest power beams.

At step 4 of FIG. 5, the BS 134 transmits a short term reference signal (e.g., CSI-RS) via n transmit beams. The short term reference signal may be a reference signal with a relatively short period (e.g., a shorter period than the long-term reference signal transmitted in step 1). n may be the same as m, or n may be different than m. For example, n may be less than m. In an illustrative example, if m=6, then the BS may transmit the short-term reference signal via n=3 or 4 transmit beams (e.g., that have a highest RSRP), for example. This is merely one illustrative example, and any numbers may be used. Also at step 4, the BS 134 configures (or notifies the UE 132) of the resource location for each of the n beams used to transmit the short term reference signal. In an example implementation, the short term reference signal may be transmitted to the UE 132 to allow the UE 132 to perform channel or CSI (channel state information) measurement, such as channel coefficients (h), rank indication (RI), channel quality indication (CQI)—e.g., for the n largest (or best) BS transmit beams, which may be less than m, for example.

At step 5 of FIG. 5, the BS 134 selects or determines, e.g., based on a reported RSRP value and a beam index for each of the m BS transmit beams, a first number (n1) of diagonal correlation (auto-correlation) coefficients of a correlation matrix and a second number (n2) of non-diagonal correlation (cross-correlation) coefficients of the correlation matrix. In an example implementation, the first number (n1) of diagonal correlation coefficients/values may, for example, be the same or less than the total number of diagonal correlation coefficients of the correlation matrix. Also, in an example implementation, the second number (n2) of the non-diagonal correlation coefficients may be less than all of the non-diagonal correlation coefficients of the correlation matrix. Thus, for example, a correlation coefficient with (beam) indices i, j represents or indicates the correlation of BS transmit beam i and BS transmit beam j. The diagonal correlation coefficients represent a correlation of a BS transmit beam with itself (i=j), which may be referred to as auto-correlation coefficients. While the non-diagonal correlation (cross-correlation) coefficients for the correlation matrix represent or indicate the correlation of two different BS transmit beams, such as a correlation of BS transmit beam i with BS transmit beam j, with i not equal to j (different beams), which may be referred to as cross-correlation coefficients. In an example implementation, n1 maybe set equal to m, and n2 maybe larger than m. BS 134 may select n1 and n2, e.g., based on m reported RSRP values. In selecting n1 and n2, BS 134 may consider performance (e.g., performance may increase with larger n1, n2, for example), and overhead (e.g., but larger n1, n2 may create more signaling overhead).

At step 6 of FIG. 5, the UE 132 selects (or determines) beam indices of a subset of correlation coefficients (to be measured and reported to BS 134 later via steps 7-8 below based on short term reference signal) based on the measured power/RSRP for the m largest/best transmit beams based on the measured power/RSRP of the long term reference signal received at steps 1 and 3. Several different techniques may be used to select beam indices (i, j) of a subset of correlation coefficients to be measured and reported to the BS 134. The subset of beam indices may include, for example, beam indices for a first number (n1) of diagonal correlation (auto-correlation) coefficients (with i=j), and a second number (n2) of non-diagonal correlation (cross-correlation) coefficients. In a first example implementation, a power (or RSRP) product may be determined (based on measured RSPR from the long term reference signal) for each of the correlation coefficients, and then the beam indices for the n1 diagonal correlation coefficients having the greatest/highest power product, and the beam indices for the n2 non-diagonal correlation coefficients having the greatest/highest power product are selected for feedback. These power product(s) may provide an estimate of a correlation coefficient, and thus, may be used to select indices of correlation coefficients to be later measured and fed back to the BS 134 based on the short term reference signal.

With respect to step 6, in an illustrative example, a power product for diagonal correlation coefficients may be determined, for example, as (or based upon) a product of RSRPᵢ*RSRpⱼ, or \sqrt{RSRPⱼ*RSRPᵢ} or \sqrt{RSRPⱼ/RSRPᵢ} (which is based on a power division), where i and j are beam indices of a correlation coefficient, and where * indicates a multiplication operation. Thus, to determine the largest n1 diagonal (auto-correlation) coefficients (with i=j), a power product may be determined, for example, as \sqrt{RSRPᵢ*RSRPᵢ}, which is =RSRPᵢ. Both UE 132 and BS 134 may determine the indices for the n1 diagonal correlation coefficients having the highest power product (or highest estimated correlation coefficient) based on long term reference signal, and determine the indices for the n2 non-diagonal correlation coefficients having the highest power product (or estimated correlation coefficient) based on long term reference signal, because both UE 132 and BS 134 have the measured RSRP values and beam indices for the m largest BS transmit beams, and both UE 132 and BS 134 may determine and order the power products (or correlation estimates based on long term reference signal) using a same set of rules, in order to select the beam indices of n1 and n2 correlation coefficients to be reported. According to an example implementation, the UE 132 does not feed back or report these power products or estimated correlation coefficients, but merely determines the beam indices for the n1+n2 correlation coefficients to be later measured and reported based on the received short term reference signal. Thus, at step 6, the UE determines the indices of correlation values/coefficients for feedback, which are n1 largest long-term auto-correlation values (or estimates of such long term auto-correlation values, which may be estimated based on the power products or RSRPᵢ) and n2 largest long term cross-correlation values (or estimates of such long term cross-correlation values, which may be estimated based on the power products) in the correlation matrix

At step 7 of FIG. 5, the UE 132 receives the short term reference signal via n BS transmit beams, and determines, based on the selected beam indices (from step 6) and the short term reference signal, the subset of correlation coefficients (of the correlation matrix) for the selected beam indices. For example, the UE 132 may determine a channel coefficient (hᵢ) for each BS transmit beam, e.g., representing a gain and phase change for a channel via the transmit beam, based on the received short term reference signal. Then, based on the channel coefficient for each of the plurality of transmit beams, the UE 132 may determine a correlation coefficient (r) that represents or indicates a correlation between the two BS transmit beams/antenna ports. In this manner, the UE 132 may determine the n1 diagonal correlation (cross-correlation) coefficients and the n2 non-diagonal correlation (cross-correlation) coefficients, according to the selected beam indices in step 6. Thus, according to an example implementation, the beam indices of correlation coefficients are identified in step 6 based on the long term reference signal, and then the correlation coefficients for the identified beam indices are measured or determined in step 7 based on the short term reference signal.

Also at step 7 of FIG. 5, the UE 132 may normalize the measured/determined (short term) correlation coefficients. For example, each correlation coefficient, for beams i, j, may be normalized based on the measured power or RSRP for the beams i, j. Thus, for example, a correlation coefficient with beam indices i, j may be normalized by dividing the correlation coefficient by \sqrt{RSRPⱼ*RSRPᵢ}, for example, where RSRPᵢ and RSRPⱼ, are the measured powers (RSRP) of the long term reference signal for beams i and j, respectively. In this manner, a subset (e.g., n1 diagonal+n2 non-diagonal) of non-zero normalized coefficients may be determined by the UE 132. UE 132 and BS 134 may assume that the other correlation coefficients are zero, hence providing a sparse (few or limited number of non-zero coefficients) correlation matrix. Normalization of the correlation coefficients may be useful since it may reduce the quantization range for the correlation coefficients. Thus, normalization may allow for a more efficient quantization of the correlation coefficients.

At step 8 of FIG. 5, the normalized (short term) correlation coefficients (determined in step 7) are quantized by UE 132 for transmission to BS 134. According to an example implementation, a finite alphabet set with different amplitude and phase levels may be used for quantization of the correlation coefficients. Per element/coefficient quantization and feedback can be used to reduce complexity. Different finite alphabet sets can be used for quantization and feedback for diagonal and non-diagonal correlation coefficients/values. Also, a different modulation may be used for non-diagonal (cross-correlation) coefficients and diagonal (auto) correlation coefficients. According to an illustrative example implementation, quantizing of the correlation coefficients may be performed by the UE 132, wherein a first constellation set with amplitude and phase is used for quantization of non-diagonal (cross) correlation coefficients, and wherein a second constellation set with only positive real numbers is used for quantization of diagonal (auto) correlation values/coefficients. According to illustrative example implementations, QAM (quadrature amplitude modulation) may be used for quantization and feedback for non-diagonal elements/coefficients, such as 16QAM. And, PAM (pulse amplitude modulation—but with only using the positive values of PAM; omitting the negative values, because correlation values should be a positive value) using only positive values are used for quantization and feedback for diagonal elements/coefficients, such as 4PAM with using only positive constellation points of PAM to quantize the diagonal correlation values. The spatial correlation matrix may be a Hermitian matrix. As such, it has a conjugation and transposition property. Therefore, according to an example implementation, only half of the non-diagonal correlation values are needed to be reported or fed back to the BS 134. Correlation coefficients, rᵢⱼ, rⱼᵢ have a relationship, so only need to report or feed back half of these correlation coefficients, according to an example implementation.

At step 9 of FIG. 5, the BS/eNB receives the reported/fed back normalized and quantized n1 diagonal correlation coefficients and n2 non-diagonal correlation coefficients, and then generates (or restores) the correlation matrix based on th received normalized correlation coefficients, RSRP values for each BS transmit beam/beam index (measured based on long term reference signals at step 6), and the derived beam indices for the non-zero/subset of (n1 and n2) correlation coefficients. The other (non-transmitted) correlation coefficients will be assumed to be zero, hence the transmission of the n1+n2 non-zero correlation coefficients may be referred to as a transmission of a sparse correlation matrix (R). The BS 134 un-normalizes (or de-normalizes) the received correlation coefficients, e.g., by multiplying the received normalized coefficient by the power product, such as by multiplying each received non-diagonal correlation coefficient for beams i, j by its \sqrt{RSRPⱼ*RSRPᵢ}, and multiplying each diagonal normalized correlation coefficient by its RSRPᵢ, for example (e.g., the same power products used to normalize each correlation coefficient).

At step 10 of FIG. 5, the BS 134 may perform efficient SU/MU-MIMO transmission based on explicit feedback in the form of the transmitted sparse spatial correlation matrix R (including the n1 diagonal correlation coefficients and n2 non-diagonal correlation coefficients) from UE 132 and possibly other feedback, such as RI, CQI, etc., received from the UE 132. According to an example implementation, the BS 134 may have both signal spatial information and null space information based on sparse (only n1+n2 correlation coefficients BS are fed back to eNB) spatial correlation matrix R feedback from UE 132 to BS 134. Also, a SLNR (Signal leakage noise ratio) based algorithm can also be used for MU-MIMO with spatial correlation matrix feedback. In an example implementation, only a subset of correlation coefficients/values are sent to the BS 134 (to reduce feedback overhead), and the coefficients may be normalized to reduce the range of quantization.

Further illustrative example details will be briefly described, according to various alternative examples. For explicit feedback scheme with sparse R (correlation matrix), it has the following characteristics:
Feedback non-zero correlation value for sparse R
   Need not feed back/report zero or near-zero correlation coefficients/values (these are assumed by BS 134 to be zero, thereby taking advantage of sparse R and reducing feedback overhead)
   Indices of non-zero correlation coefficients can be implicitly determined by BS 134 and need not be reported/feedback by UE 132
Multiple RSRP reporting by UE 132 to BS 134 for different antenna ports/transmit beams (e.g., based on long term reference signal)
   Used for determining the indices of non-zero correlation coefficients/values in correlation matrix R
   Used for normalization and un-normalization of correlation coefficients
Normalized R feedback by its corresponding RSRP(s)—normalizing the correlation coefficients:
   Reduces the dynamic range for quantization
   Achieves better CSI accuracy with given feedback overhead
The implicit principle for determining the non-zero correlation coefficients/values may be based on long term reference signals correlation value, such as based on power products or RSRP values
   For diagonal elements/coefficients: the indices are determined by RSRP value (RSRPᵢ); the indices of configured number (e.g., n1) of largest values are selected for feedback
   For non-diagonal elements/coefficients: the indices may be determined by RSRP product (\sqrt{RSRPⱼ*RSRPᵢ}) or RSRP division (\sqrt{RSRPⱼ/RSRPᵢ}) of corresponding channel components, where RSRP product principle denotes selecting the elements with large statistical correlation values and RSRP division principle denotes selecting the elements with large statistical leakage power relative signal power.

Therefore, according to an example implementation, one or more example implementations may have a number of advantageous features and advantages, such as, for example:
1) Explicit sparse spatial correlation matrix feedback, e.g. only the non-zero correlation values with configured number are fed back
2) Multiple RSRP reporting for quantization and determining the indices of non-zero values in spatial correlation matrix
3) Normalized spatial correlation matrix feedback by its corresponding RSRP(s)
4) RSRP product principle or RSRP division principle for determining indices of non-diagonal non-zero elements in spatial correlation matrix
5) Constellation set with amplitude and phase is used for non-diagonal element quantization and constellation set with only positive real number is used for diagonal element quantization

Example BS/eNB Operation:

To make efficient SU/MU-MIMO transmission based on sparse spatial correlation matrix feedback, some reference signals are transmitted. Related configuration information may also be sent to signal to UE for measurement. Some example details may include:
1. BS/eNB transmitted long term CSI-RS for each antenna port/transmit beam RSRP measurement;
2. BS sends configuration signaling for long term CSI-RS and the configured number for RSRP reporting. The configuration information can be the subframe, time-frequency resource location, port number, sequence, power ratio, quasi-colocation information for CSI-RS as in LTE system;
3. After UE feeds back RSRP measurement results, BS transmits short term CSI-RS for CSI measurement based on RSRP feedback;
4. BS sends configuration signaling for short term CSI-RS and the configured number of diagonal elements and non-diagonal elements for spatial correlation matrix;
   A. If the number of diagonal element is restricted to be equal to the number of short number CSI-RS, the configured signaling for diagonal element number can be omitted.
5. After UE feeds back normalized sparse spatial correlation matrix R, BS restores spatial correlation matrix by normalized non-zero correlation values, RSRP values and derived indices for nonzero values by RSRP product (or division) principle on long term spatial correlation matrix;
6. Based on restored correlation matrix and/or determined channel coefficients h (based on restored correlation coefficients) and other feedback information, such as RI, CQI, BS makes efficient SU/MU-MIMO transmission.

Example UE Operation:

From UE's side, UE will provide efficient feedback for BS to make SU/MU-MIMO transmission. The details may include:
1. UE makes measurement and feeds back configured number of largest RSRP values and their corresponding indices; To save feedback overhead, the maximum RSRP value can be fed back with absolute value and other values can be further fed back by differential values.
2. UE selects indices of correlation values for feedback according to long term correlation values (based on long term reference signal) and configured number for feedback, including number for diagonal elements and number for non-diagonal elements. Thus, the feedback overhead can be softly controlled by BS. It can flexibly determine feedback overhead according to its requirement on CSI accuracy, real uplink transmission condition and UE's uplink feedback capability.
3. UE performs normalization for selected spatial correlation coefficients/values by its corresponding RSRP(s). The dynamic range for quantization can be reduced. Thus, a trade-off can be achieved between feedback accuracy and feedback overhead.
4. UE makes quantization and feedback for normalized non-zero correlation coefficients/values. The quantization can be made for non-diagonal and diagonal elements, respectively. The diagonal correlation coefficient/element may be quantized as a positive real number and PAM with positive constellation points. The non-diagonal correlation coefficient/element may be quantized complex number and constellation points with combination amplitude and phase can be used, such 16QAM. To simplified realization and standardization complexity, per element quantization and feedback scheme can be used. Vector quantization can be further considered as an enhanced scheme with good balance on feedback accuracy, feedback overhead and realization complexity.

Further illustrative example implementation details are now provided with respect to various techniques that may be used to determine correlation coefficients (such as the non-diagonal correlation coefficients). Channel coefficient is defined as hᵢ where j is the index of receive antenna, i is the index of transmit antenna. The element of channel correlation matrix R (R=H^{H}H) can be expressed as:

$$\begin{matrix}{r}_{m , n} = {\sum }_{k = 1}^{{n}_{rx}} {h}_{k , m}^{*} {h}_{k , n} ( 1 \leq m , n \leq {n}_{tx} ) \\ = {\sum }_{k = 1}^{{n}_{rx}} {RSRP}_{m} {RSRP}_{n} \frac{{h}_{k , m}^{*}}{{RSRP}_{m}} \frac{{h}_{k , n}}{{RSRP}_{n}}\end{matrix} \qquad ( 1 )$$

where nₜₓ, nᵣₓ are the number of transmit antenna, receive antenna, respectively; RSRPₘ is the RSRP value of antenna port m. Subarray structure is one simple architecture for realization, where one subarray can generate one directional beam and thus one channel component. On account of large antenna space between center elements of different subarrays, similar statistical uncorrelation can be assumed for different channel components. Thus, from statistical view, channel correlation matrix can be approximately expressed as:

$${r}_{m , n} = {RSRP}_{m} {RSRP}_{n} {\sum }_{k = 1}^{{n}_{rx}} \frac{{h}_{k , m}^{*}}{{RSRP}_{m}} \frac{{h}_{k , n}}{{RSRP}_{n}} \approx {A}_{m , n} \times {RSRP}_{m} {RSRP}_{n} \approx A \times {RSRP}_{m} {RSRP}_{n} \qquad ( 2 )$$

Therefore, a large RSRP product may serves as a principle or basis for selecting indices of non-diagonal correlation values for feedback. If the statistical model for A_{m,n} is known for both BS and UE, weighted RSRP product (A_{m,n}×RSRPₘRSRPₙ) principle can be used as an enhanced scheme. From another view, the RSRPₘ/RSRPₙ denotes the statistical ratio of leakage power relative to signal power. Thus, to keep the important leakage elements, large RSRP ratio serves as another principle for selecting indices of correlation values for feedback.

As another alternative, the UE can determine the indices of correlation values for feedback in spatial correlation matrix and feed back the indices to eNB. It can provide more flexibility at UE side for selection. On the other hand, the feedback overhead will be larger if large number of correlation values need feedback. There is a trade-off between feedback overhead and selection flexibility.

Example Benefits/Advantages:

Sparse R based explicit feedback may include one or more of the following benefits or advantages:
Provide accurate channel state information
   Good support for MU-MIMO transmission
Good scalability for receive antenna number
   Feedback overhead may be irrelevant with receive antenna number
May be effective for different level feedback granularity, for example: PRB (physical resource block)/subband/wideband feedback and/or long term feedback
Effective quantization by long term power normalization
   Reduce dynamic range for quantization by normalization
Good tradeoff between feedback overhead and system performance
   Reasonable overhead with exploiting sparse channel property
   Reduce overhead without feedback for indices of non-zero correlation values by implicit sorting principle, such as RSRP product or RSRP ratio
   Soft overhead property and controlled overhead by eNB

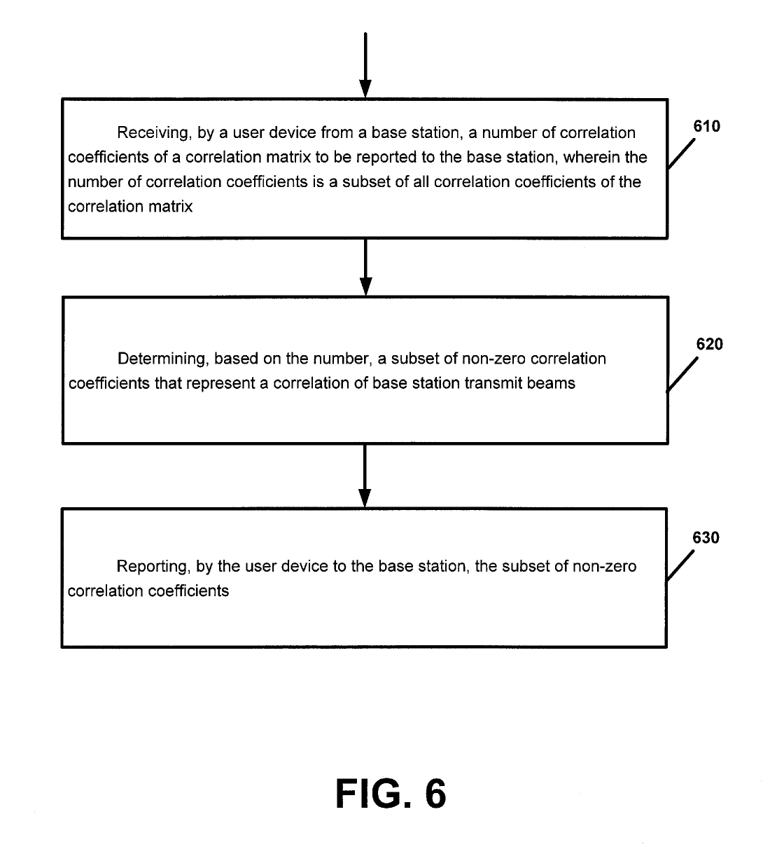

FIG. 6 is a flow chart illustrating operation of a user device according to an example implementation. Operation 610 includes receiving, by a user device from a base station, a number of correlation coefficients of a correlation matrix to be reported to the base station, wherein the number of correlation coefficients is a subset of all correlation coefficients of the correlation matrix. Operation 620 includes determining, based on the number, a subset of non-zero correlation coefficients that represent a correlation of base station transmit beams. And, operation 630 includes reporting, by the user device to the base station, the subset of non-zero correlation coefficients.

According to an example implementation of the method of FIG. 6, the receiving a number of correlation coefficients may include: receiving a first number of diagonal correlation coefficients of the correlation matrix to be reported to the base station, the first number being less than or equal to all of the diagonal correlation coefficients; and receiving a second number of non-diagonal correlation coefficients of the correlation matrix to be reported to the base station, the second number being less than all of the non-diagonal correlation coefficients.

According to an example implementation of the method of FIG. 6, the determining the subset of non-zero correlation coefficients that represent correlation of base station transmit beams may include: receiving a reference signal via a plurality of transmit beams; determining indices of diagonal correlation coefficients; and determining indices of non-diagonal correlation coefficients.

According to an example implementation, an apparatus may include at least one processor and at least one memory including computer instructions, when executed by the at least one processor, cause the apparatus to perform the method of: receiving, by a user device from a base station, a number of correlation coefficients of a correlation matrix to be reported to the base station, wherein the number of correlation coefficients is a subset of all correlation coefficients of the correlation matrix; determining, based on the number, a subset of non-zero correlation coefficients that represent a correlation of base station transmit beams; and reporting, by the user device to the base station, the subset of non-zero correlation coefficients.

According to an example implementation, a computer program product, the computer program product comprising a computer-readable storage medium and storing executable code that, when executed by at least one data processing apparatus, is configured to cause the at least one data processing apparatus to perform a method of: receiving, by a user device from a base station, a number of correlation coefficients of a correlation matrix to be reported to the base station, wherein the number of correlation coefficients is a subset of all correlation coefficients of the correlation matrix; determining, based on the number, a subset of non-zero correlation coefficients that represent a correlation of base station transmit beams; and reporting, by the user device to the base station, the subset of non-zero correlation coefficients.

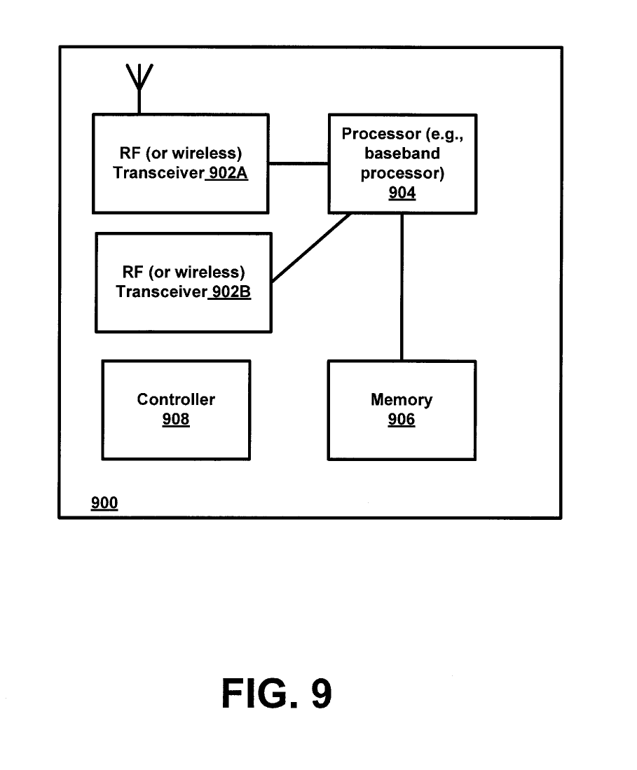

According to an example implementation, an apparatus may include means (e.g., 902A/902B, and/or 904, FIG. 9) for receiving, by a user device from a base station, a number of correlation coefficients of a correlation matrix to be reported to the base station, wherein the number of correlation coefficients is a subset of all correlation coefficients of the correlation matrix; means (e.g., 902A/902B, and/or 904, FIG. 9) for determining, based on the number, a subset of non-zero correlation coefficients that represent a correlation of base station transmit beams; and, means (e.g., 902A/902B, and/or 904, FIG. 9) for reporting, by the user device to the base station, the subset of non-zero correlation coefficients.

According to an example implementation of the apparatus, the means for receiving a number of correlation coefficients may include: means (e.g., 902A/902B, and/or 904, FIG. 9) for receiving a first number of diagonal correlation coefficients of the correlation matrix to be reported to the base station, the first number being less than or equal to all of the diagonal correlation coefficients; and means (e.g., 902A/902B, and/or 904, FIG. 9) for receiving a second number of non-diagonal correlation coefficients of the correlation matrix to be reported to the base station, the second number being less than all of the non-diagonal correlation coefficients.

According to an example implementation of the apparatus, the means for determining the subset of non-zero correlation coefficients that represent correlation of base station transmit beams may include: means (e.g., 902A/902B, and/or 904, FIG. 9) for receiving a reference signal via a plurality of transmit beams; means (e.g., 902A/902B, and/or 904, FIG. 9) for determining indices of diagonal correlation coefficients; and means (e.g., 902A/902B, and/or 904, FIG. 9) for determining indices of non-diagonal correlation coefficients.

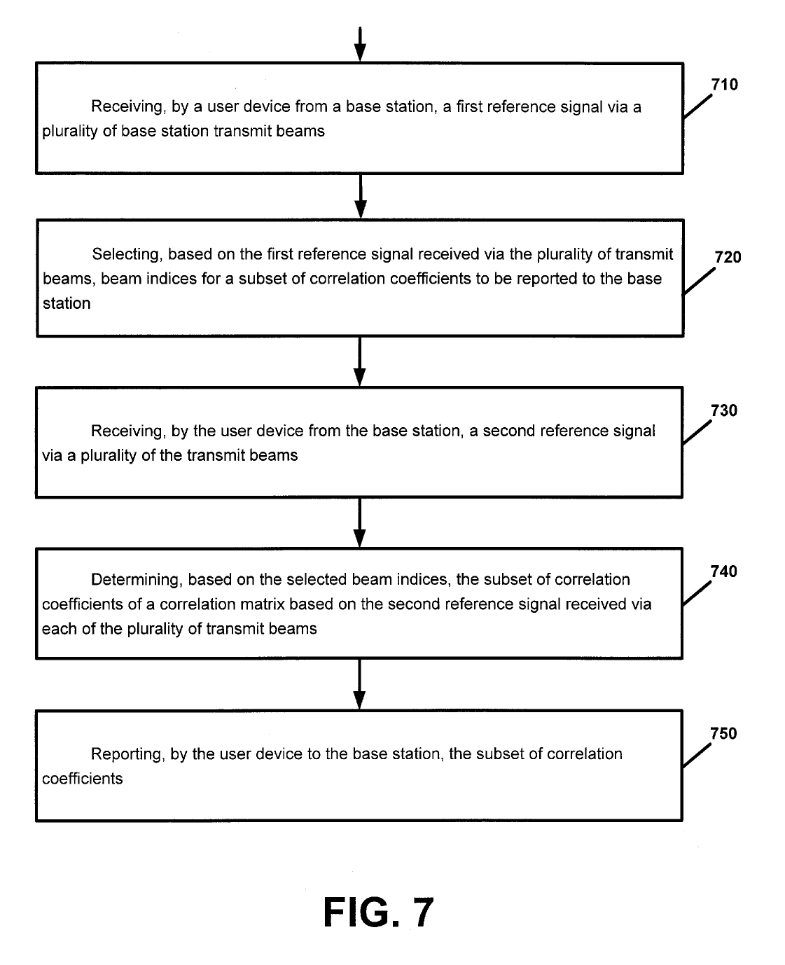

FIG. 7 is a flow chart illustrating operation of a user device according to another example implementation. Operation 710 includes receiving, by a user device from a base station, a first reference signal via a plurality of base station transmit beams. Operation 720 includes selecting, based on the first reference signal received via the plurality of transmit beams, beam indices for a subset of correlation coefficients to be reported to the base station. Operation 730 includes receiving, by the user device from the base station, a second reference signal via a plurality of the transmit beams. Operation 740 includes determining, based on the selected beam indices, the subset of correlation coefficients of a correlation matrix based on the second reference signal received via each of the plurality of transmit beams. Operation 750 includes reporting, by the user device to the base station, the subset of correlation coefficients.

According to an example implementation of the method of FIG. 7, wherein the receiving a first reference signal via a plurality of base station transmit beams may include receiving, by a user device from a base station, a long-term reference signal via a plurality of base station transmit beams; and wherein the receiving a second reference signal via a plurality of the transmit beams may include receiving, by the user device from the base station, a short-term reference signal via a plurality of the transmit beams.

According to an example implementation of the method of FIG. 7, wherein the selecting beam indices for a subset of correlation coefficients to be reported to the base station may include: measuring a power of the first reference signal received via each of the plurality of transmit beams, each of the transmit beams associated with a beam index; and selecting, based on the measured power of the first reference signal received via each of the plurality of transmit beams, beam indices for a subset of correlation coefficients to be reported to the base station.

According to an example implementation of the method of FIG. 7, wherein the selecting may include: selecting beam indices, based on largest measured power associated with the transmit beams, of a first number of diagonal correlation (auto-correlation) coefficients of the correlation matrix; and selecting beam indices, based on largest measured power associated with the transmit beams, of a second number of non-diagonal correlation (cross-correlation) coefficients of the correlation matrix.

According to an example implementation of the method of FIG. 7, wherein the measuring a power of the first reference signal received via each of the plurality of transmit beams may include: measuring a plurality of reference signal received powers (RSRPs), including a RSRP of the first reference signal received via each of the plurality of transmit beams.

According to an example implementation of the method of FIG. 7, wherein the determining the subset of correlation coefficients may include: determining, based on the selected beam indices, the subset of correlation coefficients of a correlation matrix based on the second reference signal received via each of the plurality of transmit beams; and normalizing, by the user device, each of the correlation coefficients of the subset of correlation coefficients; and wherein the reporting may include reporting, by the user device to the base station, the subset of normalized correlation coefficients.

According to an example implementation of the method of FIG. 7, wherein the normalizing may include: normalizing, by the user device based on the measured power for the beams that are represented by the correlation coefficient, each of the correlation coefficients of the subset of correlation coefficients.

According to an example implementation of the method of FIG. 7, wherein the selecting beam indices for a subset of correlation coefficients to be reported to the base station may include: measuring a power of the first reference signal received via each of the plurality of transmit beams, each of the transmit beams associated with a beam index; determining a set of largest power products for the transmit beams, each power product representing a product of a measured power for two transmit beams; and, selecting beam indices of a subset of correlation coefficients to be reported to the base station based on the determined set of largest power products for the plurality of transmit beams.

According to an example implementation of the method of FIG. 7, wherein the selecting beam indices for a subset of correlation coefficients to be reported may include selecting beam indices for a first subset of diagonal correlation (auto-correlation) coefficients of the correlation matrix and a second subset of non-diagonal correlation (cross-correlation) coefficients of the correlation matrix.

According to an example implementation of the method of FIG. 7, the method further including quantizing each correlation coefficient of the subset of correlation coefficients, wherein a first constellation set with amplitude and phase is used for quantization of non-diagonal correlation (cross-correlation) coefficients, and wherein a second constellation set with only positive real numbers is used for quantization of diagonal correlation (auto-correlation) coefficients.

According to an example implementation, a computer program product includes a computer-readable storage medium and storing executable code that, when executed by at least one data processing apparatus, is configured to cause the at least one data processing apparatus to perform a method of: receiving, by a user device from a base station, a first reference signal via a plurality of base station transmit beams; selecting, based on the first reference signal received via the plurality of transmit beams, beam indices for a subset of correlation coefficients to be reported to the base station; receiving, by the user device from the base station, a second reference signal via a plurality of the transmit beams; determining, based on the selected beam indices, the subset of correlation coefficients of a correlation matrix based on the second reference signal received via each of the plurality of transmit beams; and reporting, by the user device to the base station, the subset of correlation coefficients.

According to an example implementation, an apparatus includes at least one processor and at least one memory including computer instructions, when executed by the at least one processor, cause the apparatus to: receive, by a user device from a base station, a first reference signal via a plurality of base station transmit beams; select, based on the first reference signal received via the plurality of transmit beams, beam indices for a subset of correlation coefficients to be reported to the base station; receive, by the user device from the base station, a second reference signal via a plurality of the transmit beams; determine, based on the selected beam indices, the subset of correlation coefficients of a correlation matrix based on the second reference signal received via each of the plurality of transmit beams; and report, by the user device to the base station, the subset of correlation coefficients.

According to an example implementation, an apparatus includes means (e.g., 902A/902B, and/or 904, FIG. 9) for receiving, by a user device from a base station, a first reference signal via a plurality of base station transmit beams; means (e.g., 902A/902B, and/or 904, FIG. 9) for selecting, based on the first reference signal received via the plurality of transmit beams, beam indices for a subset of correlation coefficients to be reported to the base station; means (e.g., 902A/902B, and/or 904, FIG. 9) for receiving, by the user device from the base station, a second reference signal via a plurality of the transmit beams; means (e.g., 902A/902B, and/or 904, FIG. 9) for determining, based on the selected beam indices, the subset of correlation coefficients of a correlation matrix based on the second reference signal received via each of the plurality of transmit beams; and, means (e.g., 902A/902B, and/or 904, FIG. 9) for reporting, by the user device to the base station, the subset of correlation coefficients.

According to an example implementation of the apparatus, wherein the means for receiving a first reference signal via a plurality of base station transmit beams may include means (e.g., 902A/902B, and/or 904, FIG. 9) for receiving, by a user device from a base station, a long-term reference signal via a plurality of base station transmit beams; and wherein the means for receiving a second reference signal via a plurality of the transmit beams may include means (e.g., 902A/902B, and/or 904, FIG. 9) for receiving, by the user device from the base station, a short-term reference signal via a plurality of the transmit beams.

According to an example implementation of the apparatus, wherein the means for selecting beam indices for a subset of correlation coefficients to be reported to the base station may include: means (e.g., 902A/902B, and/or 904, FIG. 9) for measuring a power of the first reference signal received via each of the plurality of transmit beams, each of the transmit beams associated with a beam index; and means (e.g., 902A/902B, and/or 904, FIG. 9) for selecting, based on the measured power of the first reference signal received via each of the plurality of transmit beams, beam indices for a subset of correlation coefficients to be reported to the base station.

According to an example implementation of the apparatus, wherein the means for selecting may include: means (e.g., 902A/902B, and/or 904, FIG. 9) for selecting beam indices, based on largest measured power associated with the transmit beams, of a first number of diagonal correlation (auto-correlation) coefficients of the correlation matrix; and means (e.g., 902A/902B, and/or 904, FIG. 9) for selecting beam indices, based on largest measured power associated with the transmit beams, of a second number of non-diagonal correlation (cross-correlation) coefficients of the correlation matrix.

According to an example implementation of the apparatus, wherein the means for measuring a power of the first reference signal received via each of the plurality of transmit beams may include: means (e.g., 902A/902B, and/or 904, FIG. 9) for measuring a plurality of reference signal received powers (RSRPs), including a RSRP of the first reference signal received via each of the plurality of transmit beams.

According to an example implementation of the apparatus, wherein the means for determining the subset of correlation coefficients may include: means (e.g., 902A/902B, and/or 904, FIG. 9) for determining, based on the selected beam indices, the subset of correlation coefficients of a correlation matrix based on the second reference signal received via each of the plurality of transmit beams; and means (e.g., 902A/902B, and/or 904, FIG. 9) for normalizing, by the user device, each of the correlation coefficients of the subset of correlation coefficients; and wherein the means for reporting may include means (e.g., 902A/902B, and/or 904, FIG. 9) for reporting, by the user device to the base station, the subset of normalized correlation coefficients.

According to an example implementation of apparatus, wherein the means for normalizing may include: means (e.g., 902A/902B, and/or 904, FIG. 9) for normalizing, by the user device based on the measured power for the beams that are represented by the correlation coefficient, each of the correlation coefficients of the subset of correlation coefficients.

According to an example implementation of the apparatus, wherein the means for selecting beam indices for a subset of correlation coefficients to be reported to the base station may include: means (e.g., 902A/902B, and/or 904, FIG. 9) for measuring a power of the first reference signal received via each of the plurality of transmit beams, each of the transmit beams associated with a beam index; means (e.g., 902A/902B, and/or 904, FIG. 9) for determining a set of largest power products for the transmit beams, each power product representing a product of a measured power for two transmit beams; and, means (e.g., 902A/902B, and/or 904, FIG. 9) for selecting beam indices of a subset of correlation coefficients to be reported to the base station based on the determined set of largest power products for the plurality of transmit beams.

According to an example implementation of the apparatus, wherein the means for selecting beam indices for a subset of correlation coefficients to be reported may include means (e.g., 902A/902B, and/or 904, FIG. 9) for selecting beam indices for a first subset of diagonal correlation (auto-correlation) coefficients of the correlation matrix and a second subset of non-diagonal correlation (cross-correlation) coefficients of the correlation matrix.

According to an example implementation of the apparatus, the apparatus further including means (e.g., 902A/902B, and/or 904, FIG. 9) for quantizing each correlation coefficient of the subset of correlation coefficients, wherein a first constellation set with amplitude and phase is used for quantization of non-diagonal correlation (cross-correlation) coefficients, and wherein a second constellation set with only positive real numbers is used for quantization of diagonal correlation (auto-correlation) coefficients.

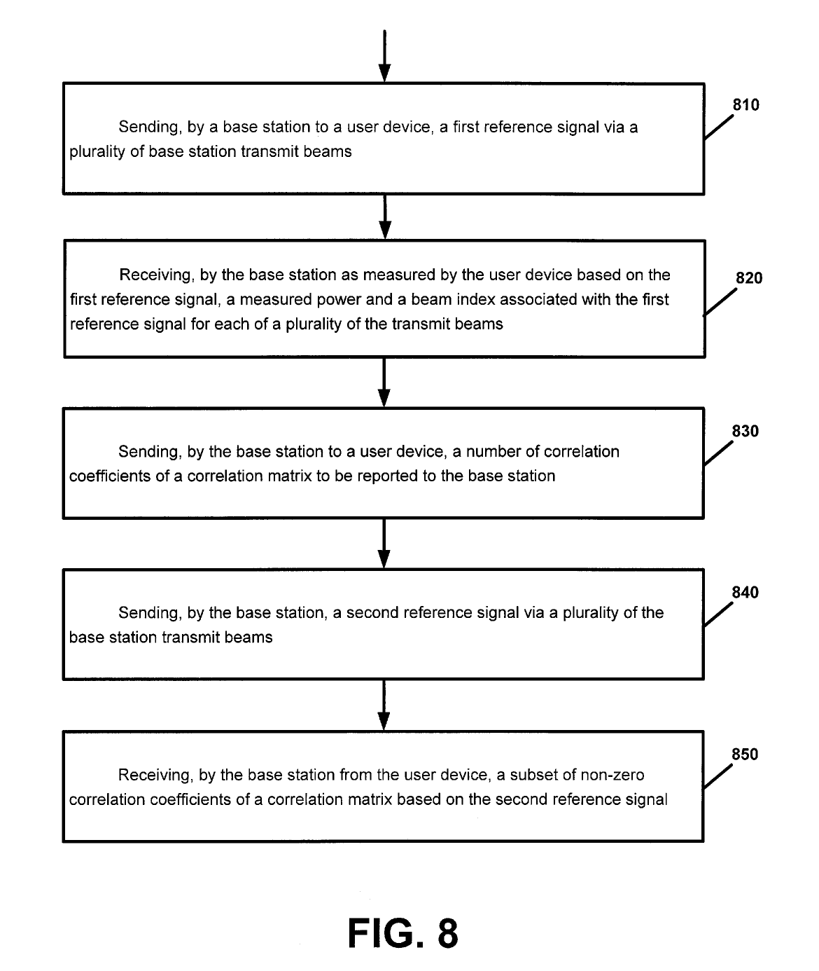

FIG. 8 is a flow chart illustrating operation of a base station according to an example implementation. Operation 810 includes sending, by a base station to a user device, a first reference signal via a plurality of base station transmit beams Operation 820 includes receiving, by the base station as measured by the user device based on the first reference signal, a measured power and a beam index associated with the first reference signal for each of a plurality of the transmit beams. Operation 830 includes sending, by the base station to a user device, a number of correlation coefficients of a correlation matrix to be reported to the base station. Operation 840 includes sending, by the base station, a second reference signal via a plurality of the base station transmit beams. And, operation 850 includes receiving, by the base station from the user device, a subset of non-zero correlation coefficients of a correlation matrix based on the second reference signal.

According to an example implementation of the method of FIG. 8, the sending, by a base station to a user device, a number of correlation coefficients of a correlation matrix to be reported to the base station may include: sending a first number of diagonal correlation coefficients of the correlation matrix to be reported to the base station, the first number being less than or equal to all of the diagonal correlation coefficients of the correlation matrix; and sending a second number of non-diagonal correlation coefficients of the correlation matrix to be reported to the base station, the second number being less than all of the non-diagonal correlation coefficients of the correlation matrix.

According to an example implementation of the method of FIG. 8, wherein the sending a first reference signal via a plurality of base station transmit beams may include sending, by the base station, a long-term reference signal via a plurality of the base station transmit beams; and wherein the sending a second reference signal via a plurality of the base station transmit beams may include sending, by the base station, a short-term reference signal via a plurality of the base station transmit beams.

According to an example implementation of the method of FIG. 8, the method further including de-normalizing each of the received correlation coefficients based on the measured power associated with the transmit beams for each of the correlation coefficients.

According to an example implementation of the method of FIG. 8, the method further including selecting beam indices, based on largest measured power associated with the transmit beams, of a first number of diagonal correlation (auto-correlation) coefficients of the correlation matrix; and selecting beam indices, based on largest measured power associated with the transmit beams, of a second number of non-diagonal correlation (cross-correlation) coefficients of the correlation matrix.

According to another example implementation, an apparatus may include at least one processor and at least one memory including computer instructions, when executed by the at least one processor, cause the apparatus to perform the method of sending, by a base station to a user device, a first reference signal via a plurality of base station transmit beams; receiving, by the base station as measured by the user device based on the first reference signal, a measured power and a beam index associated with the first reference signal for each of a plurality of the transmit beams; sending, by the base station to a user device, a number of correlation coefficients of a correlation matrix to be reported to the base station; sending, by the base station, a second reference signal via a plurality of the base station transmit beams; and receiving, by the base station from the user device, a subset of non-zero correlation coefficients of a correlation matrix based on the second reference signal.

According to another example implementation, a computer program product includes a computer-readable storage medium and storing executable code that, when executed by at least one data processing apparatus, is configured to cause the at least one data processing apparatus to perform a method of sending, by a base station to a user device, a first reference signal via a plurality of base station transmit beams; receiving, by the base station as measured by the user device based on the first reference signal, a measured power and a beam index associated with the first reference signal for each of a plurality of the transmit beams; sending, by the base station to a user device, a number of correlation coefficients of a correlation matrix to be reported to the base station; sending, by the base station, a second reference signal via a plurality of the base station transmit beams; and receiving, by the base station from the user device, a subset of non-zero correlation coefficients of a correlation matrix based on the second reference signal.

According to an example implementation, an apparatus includes means (e.g., 902A/902B, and/or 904, FIG. 9) for sending, by a base station to a user device, a first reference signal via a plurality of base station transmit beams; means (e.g., 902A/902B, and/or 904, FIG. 9) for receiving, by the base station as measured by the user device based on the first reference signal, a measured power and a beam index associated with the first reference signal for each of a plurality of the transmit beams; means (e.g., 902A/902B, and/or 904, FIG. 9) for sending, by the base station to a user device, a number of correlation coefficients of a correlation matrix to be reported to the base station; means (e.g., 902A/902B, and/or 904, FIG. 9) for sending, by the base station, a second reference signal via a plurality of the base station transmit beams; means (e.g., 902A/902B, and/or 904, FIG. 9) for receiving, by the base station from the user device, a subset of non-zero correlation coefficients of a correlation matrix based on the second reference signal.

According to an example implementation of the apparatus, the means for sending, by a base station to a user device, a number of correlation coefficients of a correlation matrix to be reported to the base station may include: means (e.g., 902A/902B, and/or 904, FIG. 9) for sending a first number of diagonal correlation coefficients of the correlation matrix to be reported to the base station, the first number being less than or equal to all of the diagonal correlation coefficients of the correlation matrix; and means (e.g., 902A/902B, and/or 904, FIG. 9) for sending a second number of non-diagonal correlation coefficients of the correlation matrix to be reported to the base station, the second number being less than all of the non-diagonal correlation coefficients of the correlation matrix.

According to an example implementation of the apparatus, wherein the means for sending a first reference signal via a plurality of base station transmit beams may include means (e.g., 902A/902B, and/or 904, FIG. 9) for sending, by the base station, a long-term reference signal via a plurality of the base station transmit beams; and wherein the means for sending a second reference signal via a plurality of the base station transmit beams may include means (e.g., 902A/902B, and/or 904, FIG. 9) for sending, by the base station, a short-term reference signal via a plurality of the base station transmit beams.

According to an example implementation of the apparatus, the apparatus further including means (e.g., 902A/902B, and/or 904, FIG. 9) for de-normalizing each of the received correlation coefficients based on the measured power associated with the transmit beams for each of the correlation coefficients.

According to an example implementation of the apparatus, the apparatus further including means (e.g., 902A/902B, and/or 904, FIG. 9) for selecting beam indices, based on largest measured power associated with the transmit beams, of a first number of diagonal correlation (auto-correlation) coefficients of the correlation matrix; and means (e.g., 902A/902B, and/or 904, FIG. 9) for selecting beam indices, based on largest measured power associated with the transmit beams, of a second number of non-diagonal correlation (cross-correlation) coefficients of the correlation matrix.

FIG. 9 is a block diagram of a wireless station (e.g., AP or user device) 900 according to an example implementation. The wireless station 900 may include, for example, one or two RF (radio frequency) or wireless transceivers 902A, 902B, where each wireless transceiver includes a transmitter to transmit signals and a receiver to receive signals. The wireless station also includes a processor or control unit/entity (controller) 904 to execute instructions or software and control transmission and receptions of signals, and a memory 906 to store data and/or instructions.

Processor 904 may also make decisions or determinations, generate frames, packets or messages for transmission, decode received frames or messages for further processing, and other tasks or functions described herein. Processor 904, which may be a baseband processor, for example, may generate messages, packets, frames or other signals for transmission via wireless transceiver 902 (902A or 902B). Processor 904 may control transmission of signals or messages over a wireless network, and may control the reception of signals or messages, etc., via a wireless network (e.g., after being down-converted by wireless transceiver 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, referring to FIG. 9, a controller (or processor) 908 may execute software and instructions, and may provide overall control for the station 900, and may provide control for other systems not shown in FIG. 9, such as controlling input/output devices (e.g., display, keypad), and/or may execute software for one or more applications that may be provided on wireless station 900, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example implementation, RF or wireless transceiver(s) 902A/902B may receive signals or data and/or transmit or send signals or data. Processor 904 (and possibly transceivers 902A/902B) may control the RF or wireless transceiver 902A or 902B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium.

Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (TOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback;

and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
receiving, by a user device from a base station, a number of correlation coefficients of a correlation matrix to be reported to the base station, wherein the number of correlation coefficients is a subset of all correlation coefficients of the correlation matrix;
determining, based on the number, a subset of non-zero correlation coefficients that represent a correlation of base station transmit beams; and
reporting, by the user device to the base station, the subset of non-zero correlation coefficients.

2. The method claim 1 wherein the receiving a number of correlation coefficients comprises:
receiving a first number of diagonal correlation coefficients of the correlation matrix to be reported to the base station, the first number being less than or equal to all of the diagonal correlation coefficients; and
receiving a second number of non-diagonal correlation coefficients of the correlation matrix to be reported to the base station, the second number being less than all of the non-diagonal correlation coefficients.

3. The method of claim 2 wherein the determining the subset of non-zero correlation coefficients that represent correlation of base station transmit beams comprises:
receiving a reference signal via a plurality of transmit beams;
determining indices of diagonal correlation coefficients; and
determining indices of non-diagonal correlation coefficients.

4. An apparatus comprising at least one processor and at least one memory including computer instructions, when executed by the at least one processor, cause the apparatus to:
receive, by a user device from a base station, a number of correlation coefficients of a correlation matrix to be reported to the base station, wherein the number of correlation coefficients is a subset of all correlation coefficients of the correlation matrix;
determine, based on the number, a subset of non-zero correlation coefficients that represent a correlation of base station transmit beams; and
report, by the user device to the base station, the subset of non-zero correlation coefficients.

5. (canceled)

6. A method comprising:
receiving, by a user device from a base station, a first reference signal via a plurality of base station transmit beams;
selecting, based on the first reference signal received via the plurality of transmit beams, beam indices for a subset of correlation coefficients to be reported to the base station;
receiving, by the user device from the base station, a second reference signal via a plurality of the transmit beams;
determining, based on the selected beam indices, the subset of correlation coefficients of a correlation matrix based on the second reference signal received via each of the plurality of transmit beams; and
reporting, by the user device to the base station, the subset of correlation coefficients.

7. The method of claim 6:
wherein the receiving a first reference signal via a plurality of base station transmit beams comprises receiving, by a user device from a base station, a long-term reference signal via a plurality of base station transmit beams; and
wherein the receiving a second reference signal via a plurality of the transmit beams comprises receiving, by the user device from the base station, a short-term reference signal via a plurality of the transmit beams.

8. The method of claim 6 wherein the selecting beam indices for a subset of correlation coefficients to be reported to the base station comprises:
measuring a power of the first reference signal received via each of the plurality of transmit beams, each of the transmit beams associated with a beam index; and
selecting, based on the measured power of the first reference signal received via each of the plurality of transmit beams, beam indices for a subset of correlation coefficients to be reported to the base station.

9. The method of claim 6 wherein the selecting comprises:
selecting beam indices, based on largest measured power associated with the transmit beams, of a first number of diagonal correlation (auto-correlation) coefficients of the correlation matrix; and
selecting beam indices, based on largest measured power associated with the transmit beams, of a second number of non-diagonal correlation (cross-correlation) coefficients of the correlation matrix.

10. The method of claim 8 wherein the measuring a power of the first reference signal received via each of the plurality of transmit beams comprises:
measuring a plurality of reference signal received powers (RSRPs), including a RSRP of the first reference signal received via each of the plurality of transmit beams.

11. The method of claim 6 wherein the determining the subset of correlation coefficients comprises:
determining, based on the selected beam indices, the subset of correlation coefficients of a correlation matrix based on the second reference signal received via each of the plurality of transmit beams; and
normalizing, by the user device, each of the correlation coefficients of the subset of correlation coefficients; and
wherein the reporting comprises reporting, by the user device to the base station, the sub set of normalized correlation coefficients.

12. The method of claim 11 wherein the normalizing comprises:
normalizing, by the user device based on the measured power for the beams that are represented by the correlation coefficient, each of the correlation coefficients of the subset of correlation coefficients.

13. The method of claim 6 wherein the selecting beam indices for a subset of correlation coefficients to be reported to the base station comprises:
measuring a power of the first reference signal received via each of the plurality of transmit beams, each of the transmit beams associated with a beam index;
determining a set of largest power products for the transmit beams, each power product representing a product of a measured power for two transmit beams;
selecting beam indices of a subset of correlation coefficients to be reported to the base station based on the determined set of largest power products for the plurality of transmit beams.

14. The method of claim 6 wherein the selecting beam indices for a subset of correlation coefficients to be reported comprises selecting beam indices for a first subset of diagonal correlation (auto-correlation) coefficients of the correlation matrix and a second subset of non-diagonal correlation (cross-correlation) coefficients of the correlation matrix.

15. The method of claim 6 and further comprising:
quantizing each correlation coefficient of the subset of correlation coefficients, wherein a first constellation set with amplitude and phase is used for quantization of non-diagonal correlation (cross-correlation) coefficients, and wherein a second constellation set with only positive real numbers is used for quantization of diagonal correlation (auto-correlation) coefficients.

16-17. (canceled)

18. An apparatus comprising at least one processor and at least one memory including computer instructions, when executed by the at least one processor, cause the apparatus to:
receive, by a user device from a base station, a first reference signal via a plurality of base station transmit beams;
select, based on the first reference signal received via the plurality of transmit beams, beam indices for a subset of correlation coefficients to be reported to the base station;
receive, by the user device from the base station, a second reference signal via a plurality of the transmit beams;
determine, based on the selected beam indices, the subset of correlation coefficients of a correlation matrix based on the second reference signal received via each of the plurality of transmit beams; and
report, by the user device to the base station, the subset of correlation coefficients.

19. A method comprising:
sending, by a base station to a user device, a first reference signal via a plurality of base station transmit beams;
receiving, by the base station as measured by the user device based on the first reference signal, a measured power and a beam index associated with the first reference signal for each of a plurality of the transmit beams;
sending, by the base station to a user device, a number of correlation coefficients of a correlation matrix to be reported to the base station;
sending, by the base station, a second reference signal via a plurality of the base station transmit beams; and
receiving, by the base station from the user device, a subset of non-zero correlation coefficients of a correlation matrix based on the second reference signal.

20. The method of claim 19 wherein the sending, by a base station to a user device, a number of correlation coefficients of a correlation matrix to be reported to the base station comprises:
sending a first number of diagonal correlation coefficients of the correlation matrix to be reported to the base station, the first number being less than or equal to all of the diagonal correlation coefficients of the correlation matrix; and
sending a second number of non-diagonal correlation coefficients of the correlation matrix to be reported to the base station, the second number being less than all of the non-diagonal correlation coefficients of the correlation matrix.

21. The method of claim 19:
wherein the sending a first reference signal via a plurality of base station transmit beams comprises sending, by the base station, a long-term reference signal via a plurality of the base station transmit beams; and
wherein the sending a second reference signal via a plurality of the base station transmit beams comprises sending, by the base station, a short-term reference signal via a plurality of the base station transmit beams.

22. The method of claim 19 and further comprising:
de-normalizing each of the received correlation coefficients based on the measured power associated with the transmit beams for each of the correlation coefficients.

23. The method of any of claim 19 and further comprising:
selecting beam indices, based on largest measured power associated with the transmit beams, of a first number of diagonal correlation (auto-correlation) coefficients of the correlation matrix; and
selecting beam indices, based on largest measured power associated with the transmit beams, of a second number of non-diagonal correlation (cross-correlation) coefficients of the correlation matrix.

24-25. (canceled)

26. An apparatus comprising at least one processor and at least one memory including computer instructions, when executed by the at least one processor, cause the apparatus to:
send, by a base station to a user device, a first reference signal via a plurality of base station transmit beams;
receive, by the base station as measured by the user device based on the first reference signal, a measured power and a beam index associated with the first reference signal for each of a plurality of the transmit beams;
send, by the base station to a user device, a number of correlation coefficients of a correlation matrix to be reported to the base station;
send, by the base station, a second reference signal via a plurality of the base station transmit beams; and
receive, by the base station from the user device, a subset of non-zero correlation coefficients of a correlation matrix based on the second reference signal.
